(19) United States
(12) Patent Application Publication
(10) Pub. No.: US 2010/0196778 A1
(43) Pub. Date: Aug. 5, 2010

(54) MANUFACTURING METHOD OF POROUS METAL ELECTRODE FOR MOLTEN CARBONATE FUEL CELLS USING DRY PROCESS

(75) Inventors: Ju Young Youn, Daejeon (KR); Bo Hyun Ryu, Daejeon (KR); Jang Yong Yoo, Yongin-si (KR); Mi Young Shin, Daejeon (KR); Hwan Moon, Seongnam-si (KR); Woon Yong Choi, Gunpo-si (KR); Tae Won Lee, Daejeon (KR); In Gab Chang, Daejeon (KR); Kil Ho Moon, Daejeon (KR)

Correspondence Address: SEED INTELLECTUAL PROPERTY LAW GROUP PLLC, 701 FIFTH AVE, SUITE 5400, SEATTLE, WA, 98104, US

(73) Assignee: DOOSAN HEAVY INDUSTRIES & CONSTRUCTION CO., LTD., Changwon-si, Gyeongsangnam-do (KR)

(21) Appl. No.: 12/594,524

(22) PCT Filed: Dec. 29, 2008
(86) PCT No.: PCT/KR08/07747

§ 371 Date: Mar. 24, 2010

(30) Foreign Application Priority Data
Dec. 28, 2007 (KR) 10-2007-0140236

(51) Int. Cl. H01M 8/14; B22F 3/11; B22F 7/04

(52) U.S. Cl. 429/478; 419/2

(57) ABSTRACT

The present invention provides a method of manufacturing a porous metal electrode for a molten carbonate fuel cell using a dry process. According to the method of manufacturing a porous metal electrode of the present invention, in the press process for controlling the thickness of dry-cast metal powder and rearranging the dry-cast metal powder, the microstructure of the porous metal electrode can be controlled, and the uniformity of the thickness of the porous metal electrode can also be controlled. Therefore, the method of manufacturing a porous metal electrode according to the present invention can be used to manufacture both an anode and a cathode.

### TECHNICAL FIELD

The present invention relates to a method of manufacturing a porous metal electrode for a molten carbonate fuel cell using a dry process.

### BACKGROUND ART

A fuel cell is a device which produces electricity by converting chemical energy stored in hydrocarbon or hydrogen fuel into electric energy.

A molten carbonate fuel cell includes an anode, a cathode and a matrix. Each of the constituents of the molten carbonate fuel cell is impregnated with an electrolyte, thus causing ion mobility between the anode and the cathode. The anode serves to produce electrons while oxidizing fuel gas (generally, hydrogen gas), and the cathode serves to consume the electrons transferred from an external circuit while forming oxygen and carbon dioxide into carbonate ions (CO₃²⁻). The carbonate ions (CO₃²⁻) produced from the cathode are transferred to the anode through an electrolyte of the matrix located between the cathode and the anode, and the electrons produced from the anode flow via an external circuit. Such an electrode reaction occurs at a triple phase interfacial boundary in which electrodes, an electrolyte and reaction gas come into contact with each other, and thus the electrodes can function as electrodes having excellent electrochemical activity by increasing the area of the triple phase interfacial boundary. Therefore, it is required that the electrolyte is properly distributed to each constituent of a fuel cell to easily perform an electrochemical oxidation-reduction reaction and ionic conduction.

An electrode for a molten carbonate fuel cell must have a large reaction area at the boundary between the electrode and an electrolyte, and must also have spaces for passing fuel and generated gas. That is, the electrode for a molten carbonate fuel cell is required to be porous in order to maximize the electrochemical reaction of electrodes, an electrolyte and fuel gas. Since an electrolyte is impregnated into pores of electrodes by capillary pressure, paths through which gas can pass even when the pores are impregnated with the electrolyte must be formed in the pores, thus forming a triple phase boundary. For this reason, the size and distribution of the pores in the electrode are very important factors.

A conventional wet tape casting technology used to manufacture a plate-like electrode for a molten carbonate fuel cell is problematic in that, although an electrode having high thickness accuracy can be manufactured, it is difficult to control the width and thickness of the electrode, the production cost of the electrode is increased due to the formation of slurry, and a process for removing organic matter is required.

Further, a commonly used wet tape casting method is also problematic in that it requires complicated processes, such as a ball-milling process, a defoaming process, a tape casting process, a drying process and the like, and thus it takes a lot of time to produce one tape or green sheet.

### DISCLOSURE OF INVENTION

### Technical Problem

As a result of efforts made by the present inventors to solve the above problems occurring in the manufacture of a plate-like electrode for a molten carbonate fuel cell using a wet tape casting technology, they manufactured a porous metal electrode for a molten carbonate fuel cell using a dry tape casting technology. As a result, they found that the porosity and pore size of the manufactured porous metal electrode can be freely changed, and that the uniformity of the thickness of the manufactured porous metal electrode can be controlled, and thus the thickness thereof is not limited at all. Based on these findings, the present invention was completed.

### Technical Solution

The present invention provides a method of manufacturing a porous metal electrode for a molten carbonate fuel cell using a dry process, and a porous metal electrode for a molten carbonate fuel cell manufactured using the method.

### BRIEF DESCRIPTION OF DRAWINGS

FIG. 1 is a block diagram showing a process of manufacturing a porous metal electrode for a molten carbonate fuel cell using a dry process according to the present invention;

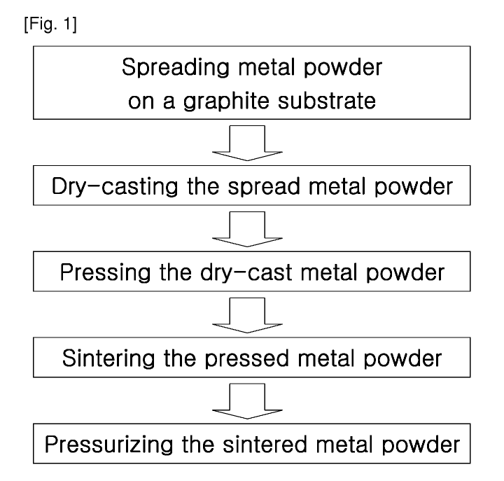

FIGS. 2A and 2B are scanning electron microscope (SEM) photographs showing microstructures of the porous metal electrode for a molten carbonate fuel cell manufactured according to the present invention (the microstructure is magnified 1000 times in FIG. 2A, and the microstructure is magnified 2500 times in FIG. 2B);

FIG. 3 is a graph showing a thickness distribution of the porous metal electrode for a molten carbonate fuel cell manufactured according to the present invention;

FIGS. 4A and 4B are graphs showing pore size distributions of the porous metal electrode for a molten carbonate fuel cell manufactured according to the present invention (in FIG. 4A, the pore sizes are represented by differential values, and in FIG. 4B, the pore sizes are represented by accumulated values); and

FIG. 5 is a graph showing a porosity distribution of the porous metal electrode for a molten carbonate fuel cell manufactured according to the present invention.

### BEST MODE FOR CARRYING OUT THE INVENTION

The present invention provides a method of manufacturing a porous metal electrode for a molten carbonate fuel cell, including the steps of: 1) spreading metal powder on a graphite substrate and then dry-casting the spread metal powder; 2) pressing the dry-cast metal powder; 3) sintering the pressed metal powder; and 4) pressurizing the sintered metal powder.

Further, the present invention provides a porous metal electrode for a molten carbonate fuel cell, manufactured by the method.

Hereinafter, steps of the method of manufacturing a porous metal electrode for a molten carbonate fuel cell according to the present invention will be described in detail.

In the method of manufacturing a porous metal electrode according to the present invention, in step 1), metal powder is spread on a graphite substrate and then dry-cast. Specifically, metal powder or metal powder coated with organics is evenly spread on a graphite substrate using a vibrator, a hopper, a blade, a brush or the like, and is then uniformly distributed and dispersed on the graphite substrate using a multistage blade. In this case, in order to uniformly spread the metal powder on the graphite substrate to have a uniform height and to prevent the metal powder from spreading to the outside of the graphite substrate, a mold may be provided, but, in the present invention, a dry-casting process is directly used without using the mold. The height of the blade must be determined in consideration of the decrease in thickness and area of the metal powder occurring during sintering, and the number and shape of the blades may be various.

The metal may be one or more selected from the group consisting of nickel, iron, copper, tungsten, zinc, manganese, and chromium. As the metal powder, metal powder alone or metal powder that includes organics such as a binder through powder pretreatment may be used.

In the method of manufacturing a porous metal electrode according to the present invention, in step 2), the dry-cast metal powder is pressed. Specifically, the dry-cast metal powder is pressed once more using a roller or a uniaxial press. In this case, while the metal powder is rearranged by the pressure transferred from the roller or the uniaxial press, the metal powder is evenly dispersed and closely packed, thus preventing cracking during sintering. Further, the porosity of a porous electrode is controlled by changing the applied pressure and height of the pressed metal powder. That is, the porosity thereof is chiefly controlled only by process variables during forming. Further, the porosity control in the manufacture of a porous electrode using a dry process may be determined by the shape and kind of the metal powder which is used.

In the method of manufacturing a porous metal electrode according to the present invention, in step 3), the pressed metal powder is sintered. In the manufacture of a porous electrode using a dry process, it is not easy to control the porosity and pore size of the porous electrode by adjusting the sintering temperature. When the pressed metal powder is heat-treated at a temperature of 650˜1050° C., preferably 700˜950° C. for 30 minutes ˜1 hour under a reducing atmosphere (N₂:H₂=96%:4%) in order to sinter the pressed metal powder, neck growth occurs between metal powder particles, and the metal powder particles mechanically combine with each other.

In the method of manufacturing a porous metal electrode according to the present invention, in step 4), the sintered metal powder is pressurized to form a porous electrode. In this case, since a plate-like porous metal structure prepared using the sintered metal powder is constricted in thickness, the porous electrode is formed by minimizing the thickness tolerance of the plate-like porous metal structure using a pinch roll (squeeze roll) including an upper roll and a lower roll or using a uniaxial press. In this case, the pinch roll (squeeze roll) may be designed to have a multistage structure in which one or more sets of rolls are provided. When the sintered powder is pressurized using the pinch roll (squeeze roll), it can be pressurized by continuously applying a predetermined load thereto using hydraulic pressure or by using a gap control process in which the gaps between rolls are maintained constant. The pinch roll (squeeze roll) or uniaxial press may have a surface made of metal, polymer, ceramic or the like.

The porous metal electrode manufactured by the method has a thickness of 0.3˜1.0 mm, a thickness tolerance of about 10 μm, a pore size of 1˜10 μm and a porosity of 30˜90%. In particular, when the porous metal electrode is a cathode, the cathode has a porosity of 80˜85%, and when the porous metal electrode is an anode, the anode has a porosity of 50˜55%.

According to the method of manufacturing a porous metal electrode of the present invention, in the press process for controlling the thickness of dry-cast metal powder and rearranging the dry-cast metal powder, the microstructure of the porous metal electrode can be controlled, and the flatness of the thickness of the porous metal electrode can also be controlled. Therefore, the method of manufacturing a porous metal electrode according to the present invention can be used to manufacture both an anode and a cathode.

### MODE FOR THE INVENTION

Hereinafter, the present invention will be described in more detail with reference to the following Examples.

A better understanding of the present invention may be obtained through the following examples which are set forth to illustrate, but are not to be construed as the limit of the present invention.

### Example 1

### Manufacture of a Porous Metal Electrode (Cathode) for a Molten Carbonate Fuel Cell

As the raw material of a dry cathode, filamentary nickel powder, manufactured by INCO Corp., was used. This nickel powder was dried at a temperature of 120° C. for 24 hours or more in order to improve its flowability. In addition to the dried nickel powder, nickel powder coated with a PVA-based binder or alloy powder in which different kinds of metal powder is mixed may be used as the raw material of the dry cathode.

The completely-dried nickel powder was spread on a graphite substrate using a hopper, and was then formed into a powder sheet having a thickness of 1.3˜1.5 mm using a multistage blade. In this case, in order to prevent the powder sheet from cracking, the multistage blade must have a blade edge angle of 10˜50° , and the blade edge should be designed to be inclined at an angle of 10° or more in the direction in which it advances.

Subsequently, the powder sheet having a thickness of 1.3 mm was pressed to a thickness of 1.1 mm using a roller such that the powder was rearranged and thus closely packed, thereby making the gaps between powder particles uniform. In this Example, the powder sheet may also be pressed using a uniaxial hydraulic press. That is, the pore size and porosity of an electrode can be controlled through a process of rearranging powder and thus making the gaps between powder particles uniform.

Subsequently, the dry-cast and pressed powder sheet was sintered together with the graphite substrate at a temperature of 750° C. for 30 minutes ˜1 hour under a reducing atmosphere (N₂:H₂=96%:4%) to manufacture an electrode plate. In this case, the pore size and porosity of the electrode plate are controlled depending on the sintering temperature and the sintering time, but there is a propensity for the change in the pore size and porosity thereof to be slight.

Thereafter, the thickness tolerance of the manufactured electrode plate having uneven thickness was controlled using a uniaxial hydraulic press. After a mold having a thickness of 0.9 mm was installed, the electrode plate was pressurized at a pressure of about 200 kg_{f}/cm² for about 10 minutes. The pressurized electrode plate had a thickness of 0.9 mm±10 μm.

### Example 2

### Manufacture of a Porous Metal Electrode (Anode) for a Molten Carbonate Fuel Cell

As the raw material of a dry anode, mixed powder (nickel-chromium powder) of filamentary nickel powder, manufactured by INCO Corp., and 10 wt % of chromium (Cr) having a particle size of 1˜5 μm was used. This mixed powder was dried at a temperature of 120° C. for 24 hours or more in order to improve its flowability. In addition to the dried mixed powder, nickel powder coated with a PVA-based binder or alloy powder in which different kinds of metal powder is mixed may be used as the raw material of the dry cathode.

The completely-dried nickel-chromium powder was spread on a graphite substrate using a hopper, and was then formed into a powder sheet having a thickness of 0.6 mm using a multistage blade. In this case, in order to prevent the powder sheet from cracking, the multistage blade must have a blade edge angle of 10˜50° , and the blade edge should be designed to be inclined at an angle of 10° or more in the direction in which it advances.

Subsequently, the powder sheet having a thickness of 0.6 mm was pressed to a thickness of 0.45 mm using a roller such that powder was rearranged and thus closely packed, thereby making the gaps between powder particles uniform In this Example, the powder sheet may also be pressed using a uniaxial hydraulic press. That is, the pore size and porosity of an electrode can be controlled through a process of rearranging powder and thus making the gaps between powder particles uniform

Subsequently, the dry-cast and pressed powder sheet was sintered together with the graphite substrate at a temperature of 950° C. for 30 minutes ˜1 hour under a reducing atmosphere (N₂:H₂=96%:4%) to manufacture an electrode plate.

Thereafter, the thickness tolerance of the manufactured electrode plate having uneven thickness was controlled using a uniaxial hydraulic press. After a mold having a thickness of 0.3 mm was installed, the electrode plate was pressurized at a pressure of about 200 kg_{f}/cm² for about 10 minutes. The pressurized electrode plate had a thickness of 0.3 mm±10 μm.

### Experimental Example 1

### Surface Characteristics of a Porous Metal Electrode of the Present Invention

In order to examine the surface characteristics of the porous metal electrode of the present invention, the surface of the porous metal electrode manufactured in Example 1 was magnified 1000 times and 2500 times using an electron microscope, and was then observed.

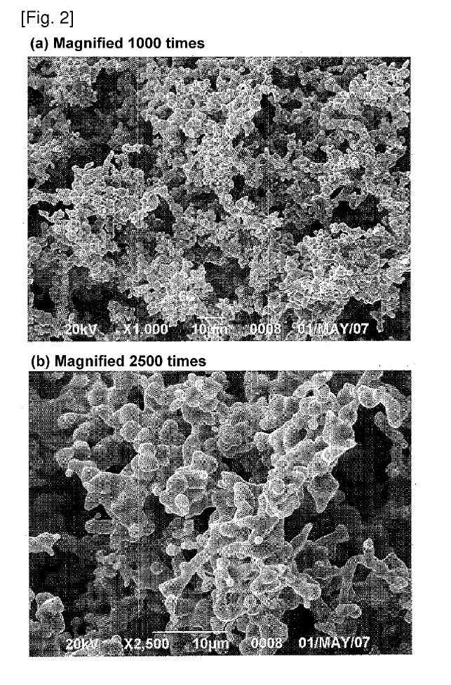

The results thereof are shown in FIG. 2.

As shown in FIG. 2, it was found that pores are distributed on the surface of the porous metal electrode of the present invention.

### Experimental Example 2

### Properties of a Porous Metal Electrode of the Present Invention

In order to examine the properties of the porous metal electrode of the present invention, 9 segments were taken as samples from the porous metal electrode manufactured in Example 1, and then the thickness tolerance, pore size and porosity of each of the samples were measured.

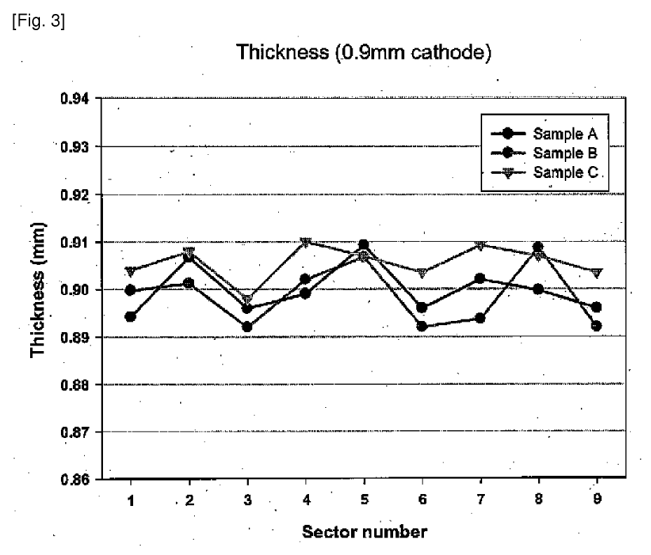

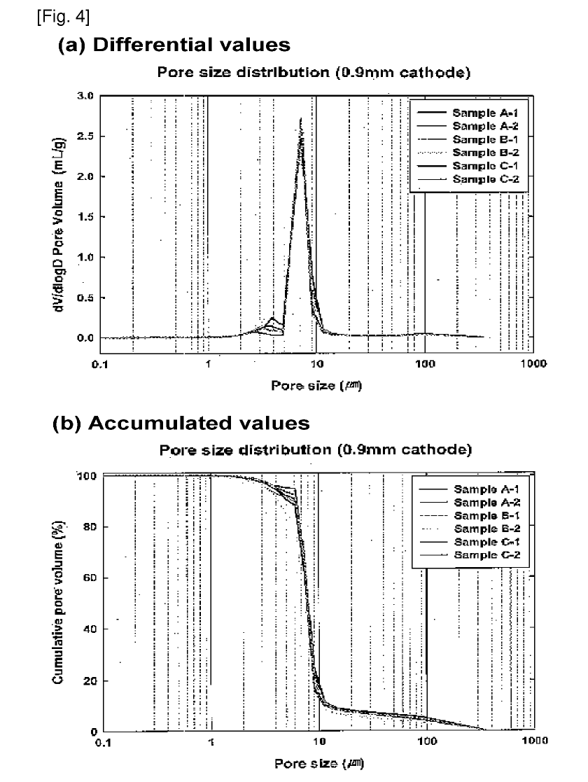

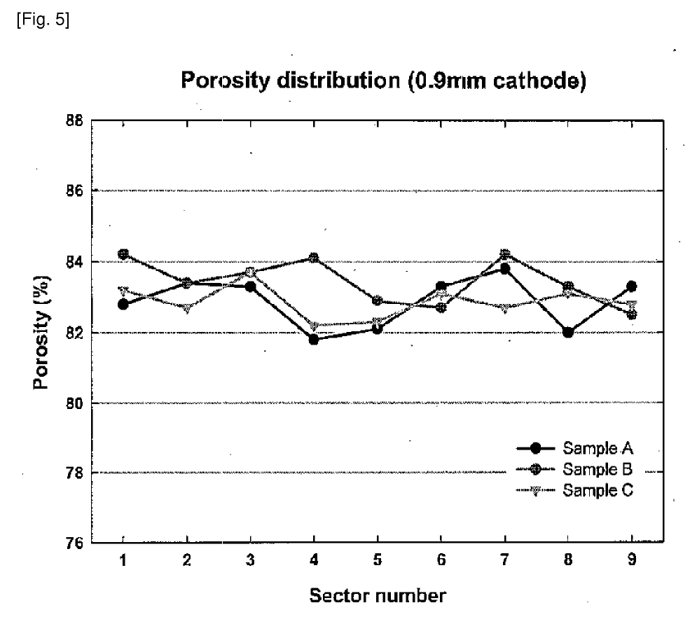

FIG. 3 shows the thickness tolerance of the porous metal electrode of the present invention, FIG. 4 shows the pore size of the porous metal electrode of the present invention, and FIG. 5 shows the porosity of the porous metal electrode of the present invention.

### INDUSTRIAL APPLICABILITY

According to the method of manufacturing a porous metal electrode of the present invention, in the press process for controlling the thickness of dry-cast metal powder and rearranging the dry-cast metal powder, the microstructure of the porous metal electrode can be controlled, and the uniformity of the thickness of the porous metal electrode can also be controlled. Therefore, the method of manufacturing a porous metal electrode according to the present invention can be used to manufacture both an anode and a cathode. Further, according to the method of manufacturing a porous metal electrode of the present invention, its process is simple, its production cost is low, and various products can be manufactured.

1. A method of manufacturing a porous metal electrode for a molten carbonate fuel cell, comprising the steps of:
1) spreading metal powder on a graphite substrate and then dry-casting the spread metal powder;
2) pressing the dry-cast metal powder;
3) sintering the pressed metal powder; and
4) pressurizing the sintered metal powder to form a porous metal electrode.

2. The method of manufacturing a porous metal electrode for a molten carbonate fuel cell according to claim 1, wherein the metal is one or more selected from the group consisting of nickel, iron, copper, tungsten, zinc, manganese, and chromium.

3. The method of manufacturing a porous metal electrode for a molten carbonate fuel cell according to claim 1, wherein, in step 3), the sintering of the pressed metal powder is performed at a temperature of 650˜1050° C. for 30 minutes ˜1 hour.

4. A porous metal electrode for a molten carbonate fuel cell, having a thickness of 0.3˜1.0 mm, a pore size of 1˜10 μm and a porosity of 30˜90%, manufactured by the method of any one of claims 1 to 3.

5. The porous metal electrode for a molten carbonate fuel cell according to claim 4, wherein the electrode is an anode or a cathode.
